(19) United States
(12) Patent Application Publication
(10) Pub. No.: US 2013/0174249 A1
(43) Pub. Date: Jul. 4, 2013

(54) SECURE LOCK FUNCTION FOR AN ENDPOINT

(71) Applicants: Jonathan Mueller, Mankato, MN (US); Christopher L. Osterloh, Waseca, MN (US); Barry Cahill-O'Brien, Spokane, WA (US)

(72) Inventors: Jonathan Mueller, Mankato, MN (US); Christopher L. Osterloh, Waseca, MN (US); Barry Cahill-O'Brien, Spokane, WA (US)

(73) Assignee: ITRON, INC., Liberty Lake, WA (US)

(21) Appl. No.: 13/343,169

(22) Filed: Jan. 4, 2012

(51) Int. Cl. G06F 21/00

(52) U.S. Cl. 726/18

(57) ABSTRACT

Disclosed are apparatus and methodology for providing secure control over stored metrology parameters. A random number key is generated and associated with identifiable information such as a serial number associated with a device. The random number and identification information are stored in a database separate and remote from the device. Alteration of the stored metrology parameters are permitted only upon use of the random number as a key to unlock the device.

### FIELD OF THE SUBJECT MATTER

The presently disclosed subject matter relates to endpoint security and, more particularly, to methodologies and corresponding and/or related apparatus for securing operating parameters stored in an endpoint.

### BACKGROUND OF THE SUBJECT MATTER

Utility meters in various forms are fairly ubiquitous in that they may be found in virtually any location from residential to industrial. Further, such meters may be provided in many forms, including meters designed to measure consumption of electricity, gas, water, oil, and/or other commodities. In many cases, a separate endpoint device may be either associated with a meter as a separate entity or, in some cases, housed together with or within the meter.

Such endpoints in general may be responsible for transmitting data collected from their associated meter to a central collection facility for billing and/or other purposes. Endpoints may also provide remote functionality relative to their associated meter including, for example, functionalities that allow disconnection of service at a particular location. Such functionality may, for example, include an ability to remotely turn off an electrical, gas, or water supply to a particular location.

Endpoints may also be configured to operate with a number of different types of meters and/or similar types of meters but having varying capacities or operating parameters. In various of those instances, it may be desired or necessary to alter parameters associated with the endpoint to match or compensate for related parameters or characteristics of an individual meter with which the endpoint is associated, for example, to ensure accurate reporting of measured quantities.

Generally customers (for example, utility companies) will install various meters and associated endpoints at consumer locations and, whether as a part of the manufacturing process or during installation, configure the endpoint for proper operation with its associated meter. Once the endpoint is properly configured, it is important that such configurations not be changed either accidentally or intentionally, for example, by unauthorized tampering with the endpoint.

While various implementations of endpoints have been developed, and while various combinations of anti-tamper and other protective features have been provided, no design has emerged that generally encompasses all of the desired characteristics as hereafter presented in accordance with the subject technology.

### SUMMARY OF THE SUBJECT MATTER

In view of the recognized features encountered in the prior art and addressed by the presently disclosed subject matter, improved apparatus and corresponding and/or related methodology for securing various endpoints devices have been provided.

Therefore, the presently disclosed subject matter in part relates to methodology for securing an endpoint. According to exemplary such methodology, a random number key may be generated and associated with an identifiable endpoint. The key and endpoint identification information may be stored in a database. In certain embodiments, the key comprises a hexadecimal number that in particular embodiments may be a 32 bit hexadecimal number.

In selected embodiments, the endpoint identification information is a serial number assigned to the endpoint. In more particular embodiments, the random number key may be generated independently of any numeric identification of the endpoint.

The presently disclosed subject matter also relates to exemplary methodologies for securing stored parameters. In accordance with such methods, a random number key may be generated and associated with an identifiable device. According to such method, the key and device identification information may be stored in a database remote from the device and alterations of the parameters may be permitted only with possession of the key.

In selected embodiments, the key may comprise generating a hexadecimal number, more particularly a 32 bit hexadecimal number, and in some embodiments the device identification information may be a serial number assigned to the device. In particular embodiments according to presently disclosed exemplary methodology, the random number key may be generated independently of any numeric identification of the device.

The presently disclosed subject matter also equally relates to corresponding and/or related metrology systems. In accordance with the presently disclosed subject matter, an exemplary such system may comprise a meter configured to generate signals indicative of measured quantities and an endpoint. In such exemplary systems, the endpoint may comprise a controller, a memory, and a communications module. Such exemplary controller may be configured to receive the signals indicative of measured quantities while the memory may store meter measurement parameters related to the signals, and which parameters may only be altered (if at all) with possession of a random number associated with the endpoint.

In accordance with certain embodiments, the endpoint may be assigned an identifying number, and the identifying number and the random number may be stored remotely from both the meter and the endpoint. In particular embodiments, the random number is a 32 bit hexadecimal number that may be generated independently of any numeric identification of the endpoint or meter.

In further embodiments of present exemplary systems, a communications module may be associated with the endpoint and configured to transmit data based on the signals indicative of measured quantities and to receive data from a remote source. In selected embodiments, the data received from the remote source may comprise the associated random number. In such embodiments of a presently disclosed exemplary system, the meter measurement parameters may be remotely altered.

In particular embodiments of a presently disclosed exemplary system, the meter may comprise one of an electric meter, a gas meter, and oil meter, and a water meter. In more particular embodiments, the endpoint may be configured to be hard locked such that the endpoint will ignore any instructions to alter the stored meter measurement parameters despite possession of the associated random number.

In accordance with still further embodiments of the presently disclosed subject matter, methodologies for enhancing measurement reliability have been provided. In accordance with such methodologies, a random number key may be generated and associated with an identifiable measurement device. The random key and device identification information may be stored in a database remote from the measurement device while measurement parameters are stored with the measurement device. In accordance with such methodologies, alterations of the measurement parameters are preferably permitted only with possession of the key.

Additional embodiments of the presently disclosed subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments and uses of the subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the presently disclosed subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the presently disclosed subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification.

### BRIEF DESCRIPTION OF THE DRAWINGS

A full and enabling disclosure of the presently disclosed subject matter, including the best mode thereof, directed to one of ordinary skill in the art, is set forth in the specification, which makes reference to the appended figures, in which:

FIG. 1 is a schematic diagram of an exemplary meter and associated endpoint constructed in accordance with exemplary presently disclosed subject matter; and

FIG. 2 illustrates a flow chart of an exemplary method for providing secure locking functionality for endpoints in accordance with the presently disclosed subject matter.

Repeat use of reference characters throughout the present specification and appended drawings is intended to represent same or analogous features, elements, or steps.

### DETAILED DESCRIPTION OF THE SUBJECT MATTER

As discussed in the Summary of the Subject Matter section, the presently disclosed subject matter is particularly concerned with systems and corresponding and/or associated methodologies for securing operating parameters stored in an endpoint. The provision of such methodologies may also be of significance in meeting regulatory agency requirements such as those promulgated by Measurement Canada or the National Institute of Standards and Technology (NIST) in the United States.

Selected combinations of aspects of the disclosed technology correspond to a plurality of different embodiments of the presently disclosed subject matter. It should be noted that each of the exemplary embodiments presented and discussed herein should not insinuate limitations of the presently disclosed subject matter. Features or steps illustrated or described as part of one embodiment may be used in combination with aspects of another embodiment to yield yet further embodiments. Additionally, certain features may be interchanged with similar devices or features not expressly mentioned which perform the same or similar function.

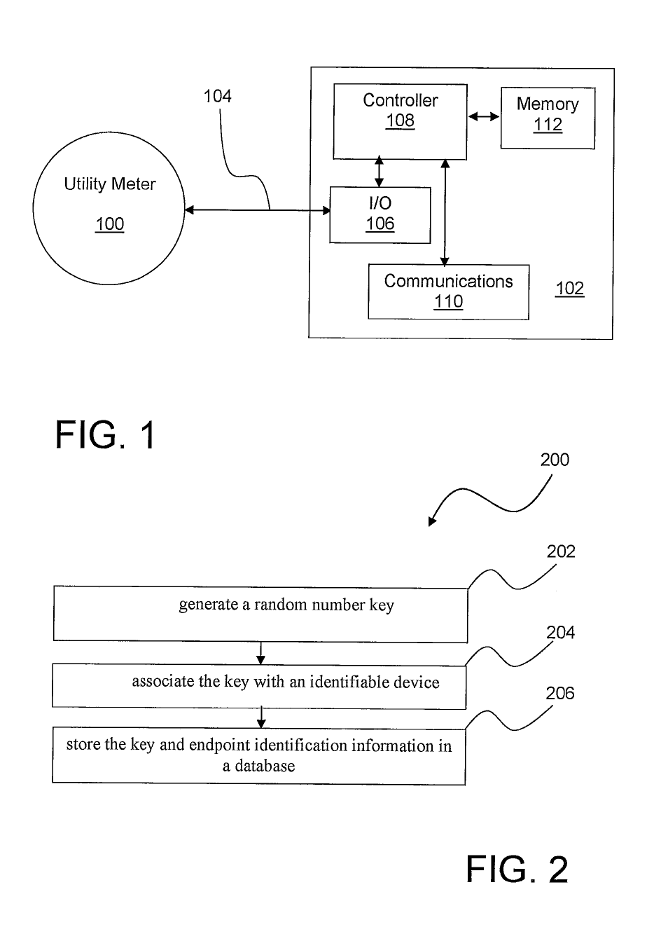

Reference is made hereafter in detail to the presently preferred embodiments of the subject secure lock functionality for endpoints. Referring to a subject drawing, FIG. 1 illustrates an exemplary meter (utility meter) generally 100 and associated endpoint 102 constructed in accordance with the presently disclosed subject matter. As illustrated in FIG. 1, exemplary meter 100 may correspond to any of several different meter types including, without limitation, electricity, gas, oil, and water meters. It should be appreciated, however, that the presently disclosed subject matter is not limited to utility consumption meters but more generally may actually be employed with any measurement device associated with some other device or system where the other device or system may be configured to store various parameters associated with the measurement device.

As is generally understood by those of ordinary skill in the art, certain parameters in an endpoint may be configurable to allow the endpoint to match at least aspects of a specific meter with which it is, or will be, associated or attached. For example, the number of cubic feet per count may be a configurable parameter for a gas meter. Such parameters, more generally identified as metrology parameters, directly affect the accurate reporting and collection of measurements performed by the meter. As such is the case, a utility may choose to require that such parameters be locked once set, so that they can not be changed, either inadvertently or intentionally, at a later date, to preserve the accuracy of the readings.

In certain instances, however, a locked endpoint device may need to be changed if, for example, the meter it is associated with needs to be changed out with a different meter or if a mistake was made during programming, or for any other reason. With continued reference to FIG. 1, it will be appreciated by those of ordinary skill in the art that meter 100 will generally be in communication with endpoint 102 by way of some form of communications, exemplarily illustrated/represented as communications pathway 104. It should be appreciated that communications pathway 104 may correspond to any known or to be developed suitable communications mechanism including, without limitation, direct wire, radio frequency (RF), optical coupling, or any other appropriate communications mechanism that permits at least one way transfer of data from meter 100 to endpoint 102. In certain embodiments, of course, it would be advantageous to provide a communications pathway 104 enabling bi-directional communications between meter 100 and endpoint 102

Regardless of transport mechanism, data may be received at endpoint 102 by way of an input/output (I/O) module generally 106 that may provide signal enhancements or may simply forward received (or transmitted) signals to (or from) controller 108. Controller 108 may typically be configured to read data from meter 100 on a predetermined basis and store such data, for example, in memory 112, for transmission at predetermined intervals or on demand through communications module 110 to, for example, a remote central facility (not separately illustrated). In certain instances, data may be transmitted from endpoint 102 to a central (ore remote) facility by way of other similar endpoints operating as repeaters before arriving at the central facility.

As previously noted, data gathered from meter 100 may be stored within endpoint 102 in representative memory 112. It is to be understood by those of ordinary skill in the art from the complete disclosure herewith that memory 112 may actually be formed within controller 108 or could, as presently illustrated, correspond to a separate storage device. In accordance with the presently disclosed subject matter, memory 112 may also store operational software for endpoint 102 as well as other data. Such other data may correspond not only to configuration data used to establish operational parameters for endpoint 102 (for example, data collection times, collection frequency, etc.,) but also metrology parameters associated with the configuration and/or calibration of meter 100. It should be noted that stored collected data from meter 100, metrology parameters for meter 100, and configuration data for endpoint 102 may all be stored in the same memory 112, or in separate portions of memory 112, or in altogether separate memory devices, all such possibilities being exemplarily represented herein by memory 112, and coming within the spirit and scope of the presently disclosed subject matter.

In accordance with the presently disclosed subject matter, exemplary methodology has been developed whereby, in particular, the metrology parameters relative to meter 100 may be “locked” within memory 112 in such manner that the data can not be inadvertently or intentionally changed without proper authorization. In accordance with the presently disclosed subject matter, such authorization takes the form of employing a randomly generated number (key) that is created at the time of endpoint manufacture. In an exemplary embodiment, such random number may correspond to a 32-bit hexadecimal number which is assigned to a specific meter but is not related to any other information associated with the meter such as, for example, an assigned serial number.

By selecting a random number as the key to unlocking the meter rather than, for example, the meter serial number or even a number derived from the serial number, an individual wishing or needing to alter information stored in the locked portion of memory 112 must consult with the manufacturer to obtain the key. The manufacturer would maintain a record of the random number that was generated for a specific meter in a data base to which only the manufacture would have access. The use of a random number has significant advantages over using, for example, some variation or derivative of an associated serial number that might be guessed or otherwise decoded.

In order to unlock a locked endpoint, a customer may obtain the random number paired with the endpoint by giving the manufacturer the serial number for the endpoint and then, in turn receiving the random number from the manufacturer. Delivery of the random number “key” may be by any suitable means including electronic or “hard copy” delivery. Following delivery of the “key,” a customer may use such key together with, for example, a portable programming tool (not separately illustrated) that may be coupled to endpoint 102 by way of communications module 110 or by alternate connection (not separately illustrated) directly to controller 108. In certain embodiments of the presently disclosed subject matter, where the endpoint is installed in a network, the manufacturer may be able to remotely unlock the endpoint by transmitting the key directly to the endpoint over the network.

As a utility installs and validates a meter, such meter can be locked per the presently disclosed subject matter after which the meter will no longer accept commands to change the metrology parameters without obtaining the random number “key” from the manufacturer. In special instances, the software (and/or hardware) within endpoint 102 may be configured to allow the endpoint to be “hard locked.” In such instances, endpoint 102 would be configured such that no commands would be accepted that would unlock the endpoint to permit any alteration of the meter parameters. Such “hard lock” (potentially a physical hard lock) of the endpoint may be undertaken should the random number key for a particular meter be compromised in any fashion or should the manufacturer's data base be compromised. In some alternative installations, hard locked devices may be reprogrammed but often such reprogramming requires physical removal of the endpoint with consequent power disruption. The use of the presently disclosed subject matter may in some instances eliminate the need to remove and/or un-seal such endpoints.

With present reference to subject FIG. 2, there is illustrated a flow chart generally 200 of presently disclosed exemplary methodology for providing secure locking functionality for endpoints in accordance with the presently disclosed subject matter. According to such exemplary method of the presently disclosed subject matter, a secure locking functionality for individually identifiable devices begins in step 202 by generating a random number. In particular embodiments, such random number may be a hexadecimal number and may be 32-bits long. Further in accordance with such exemplary presently disclosed methodology, the generated random number may be associated with an identifiable device per step 204. The identifiable device may be identified in accordance with certain aspects of the method by associating the device with a unique serial number.

Finally, in accordance with the presently disclosed subject matter, the key and endpoint identification information (possibly the serial number) are stored together in a database. In particular embodiments of the subject matter, the database may be remotely located from the endpoint and/or the meter.

While the presently disclosed subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the presently disclosed subject matter as would be readily apparent to one of ordinary skill in the art.

What is claimed is:

1. A method for securing an endpoint, comprising:
generating a random number key;
associating the key with an identifiable endpoint; and
storing the key and endpoint identification information in a database.

2. A method as in claim 1, wherein generating a key comprises generating a hexadecimal number.

3. A method as in claim 2, wherein the hexadecimal number is a 32 bit hexadecimal number.

4. A method as in claim 1, wherein the random number key is generated independently of any numeric identification of the endpoint.

5. A method as in claim 1, wherein the endpoint identification information is a serial number assigned to the endpoint.

6. A method as in claim 5, wherein generating a key comprises generating a hexadecimal number independently of any numeric identification of the endpoint.

7. A method for securing stored parameters, comprising:
generating a random number key;
associating the key with an identifiable device;
storing the key and device identification information in a database remote from the device; and
permitting alterations of the parameters only with possession of the key.

8. A method as in claim 7, wherein generating a key comprises generating a hexadecimal number.

9. A method as in claim 8, wherein the hexadecimal number is a 32 bit hexadecimal number.

10. A method as in claim 7, wherein the device identification information is a serial number assigned to the device.

11. A method as in claim 7, wherein the random number key is generated independently of any numeric identification of the device.

12. A metrology system, comprising:
a meter configured to generate signals indicative of measured quantities; and
an endpoint, said endpoint comprising a controller, a memory, and a communications module,
wherein said controller is configured to receive said signals, said memory stores meter measurement parameters related to said signals, and said endpoint is configured to require possession of an associated random number to alter the stored meter measurement parameters.

13. A system as in claim 12, wherein said endpoint is assigned an identifying number and said identifying number and said random number are stored remotely from both said meter and said endpoint.

14. A system as in claim 13, wherein said random number is a 32 bit hexadecimal number generated independently of any numeric identification of the endpoint or meter.

15. A system as in claim 12, further comprising:
a communications module associated with said endpoint,
wherein said communications module is configured to transmit data based on said signals indicative of measured quantities and to receive data from a remote source.

16. A system as in claim 15, wherein data received from said remote source comprises said associated random number, whereby said meter measurement parameters may be remotely altered.

17. A system as in claim 12, wherein said meter comprises one of an electric meter, a gas meter, and oil meter, and a water meter.

18. A system as in claim 12, wherein said endpoint is configured to be alternatively hard locked such that said endpoint will ignore any instructions to alter the stored meter measurement parameters despite possession of the associated random number.

19. A system as in claim 12, wherein:
said endpoint is assigned an identifying number;
said random number is a hexadecimal number generated independently of any numeric identification of either of said endpoint or said meter;
said identifying number and said random number are stored remotely from both said meter and said endpoint;
said system further comprises a communications module associated with said endpoint, with said communications module configured to transmit data based on said signals indicative of measured quantities and to receive data from a remote source; and
wherein data received from said remote source comprises said associated random number, whereby said meter measurement parameters may be remotely altered.

20. A method for enhancing measurement reliability, comprising:
generating a random number key;
associating the key with an identifiable measurement device;
storing the key and device identification information in a database remote from the measurement device;
associating measurement parameters with the measurement device; and
permitting alterations of the measurement parameters only with possession of the key.
